(19) United States
(12) Patent Application Publication
(10) Pub. No.: US 2009/0064843 A1
(43) Pub. Date: Mar. 12, 2009

(54) Musical rhythm instrument

(75) Inventor: Russell MILLER, Chatsworth, CA (US)

Correspondence Address: BROWDY AND NEIMARK, P.L.L.C.;624 NINTH STREET, NW, SUITE 300, WASHINGTON, DC, 20001-5303, US

(73) Assignee: Roland Meinl Musikinstrumente GmbH & Co. KG, Gutenstetten (DE)

(21) Appl. No.: 12/204,980

(22) Filed: Sep. 5, 2008

(30) Foreign Application Priority Data
Sep. 5, 2007 (DE) 10 2007 042 037.6

(51) Int. Cl. G10D 13/00

(52) U.S. Cl. 84/410

(57) ABSTRACT

The invention relates to a musical rhythm instrument (1) with a bell-shaped resonating body (2), in particular of metal, wherein a damping mechanism (13) is provided for damping the vibrations of the resonating body (2).

The invention relates to a rhythm instrument with a bell-shaped resonating body that is set into vibration with a drumstick.

Musical instruments of this type are referred to as “cowbells.” To vary their tone, it is known that the musicians press their hand against the surface of the resonating body with greater or lesser degrees of pressure. This method of damping requires the use of two hands for the respective striking and damping, i.e. such a damping is not possible if the musician wishes to continue to play a second percussion instrument with the other hand.

Proceeding from this, the invention is based on the object of improving a musical instrument of the type mentioned at the beginning in such a way that an individual tone can be set in a non-transient manner.

This object is met according to the invention in such a way that a damping mechanism for damping the vibrations of the resonating body is provided.

The damping mechanism preferably comprises a damping element, in particular of a soft material such as felt, rubber, foamed plastic or the like, that is pressable against the wall of the resonating body.

The damping element is advantageously pressed against the inner wall of the resonating body.

The damping element may be composed of components of different materials and/or different sizes, e.g. of a combination of a flat rubber pad and a smaller felt washer.

The damping element is advantageously adjustable by means of a set screw in terms of its distance from and force of pressure against the inner wall of the resonating body.

To this effect a wall of the resonating body may have formed in it a thread that is penetrated by the set screw. The thread may be formed, for instance, by a welded-on nut.

The set screw may be designed in such a way that it either presses or pulls the damping element against the inner wall of the resonating body.

With the inventive embodiment it is achieved that the tone of the musical instrument can be adjusted varyingly and lastingly, so that the musician does not need a hand to produce a damping or a change in the tone.

In an additional preferred embodiment, provision is made that the damping mechanism is disposed on a displaceable support rod and spring biased toward a damping position or an inactive position. The damping mechanism is thus in a defined starting position and can be manually displaced through actuation of the support rod against the spring bias into the respective other direction for a short-term change in the tone of the musical instrument.

The invention will be described in more detail below based on preferred exemplary embodiments in conjunction with the drawing, in which

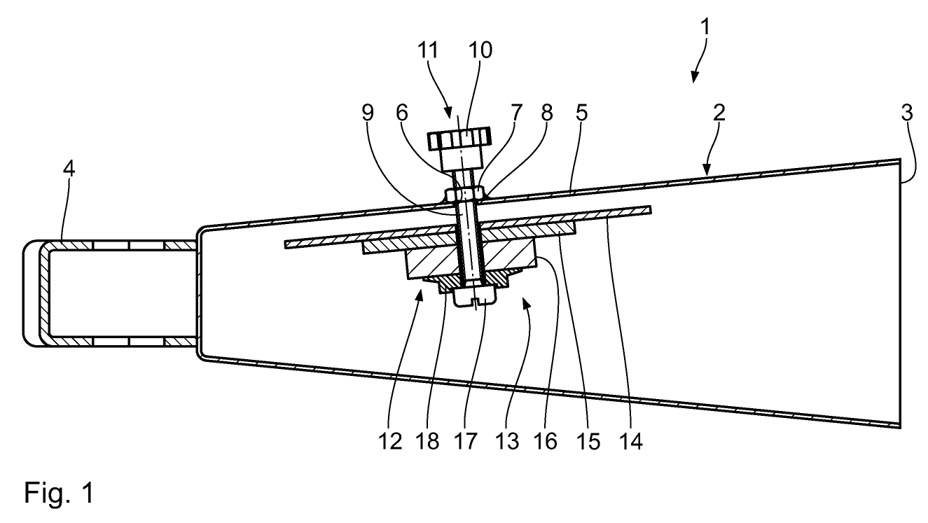

FIG. 1 shows a longitudinal section through a first embodiment of an inventive musical instrument without damping,

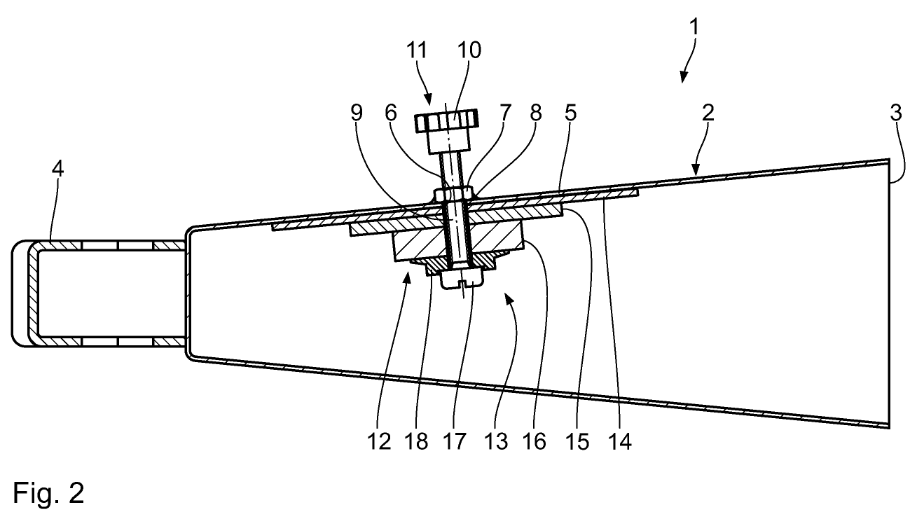

FIG. 2 shows a depiction corresponding to FIG. 1 with activated damping,

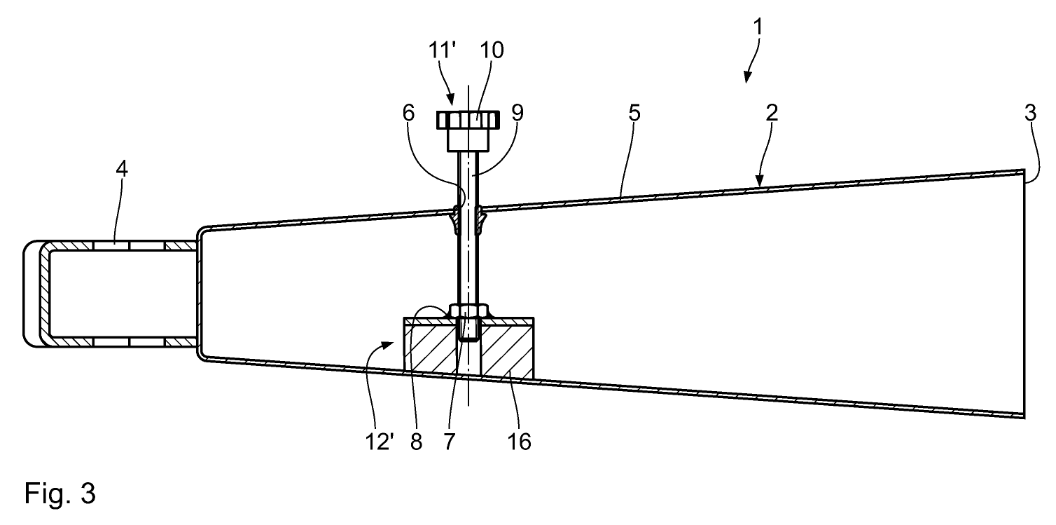

FIG. 3 shows a longitudinal section through a second embodiment with activated damping, and

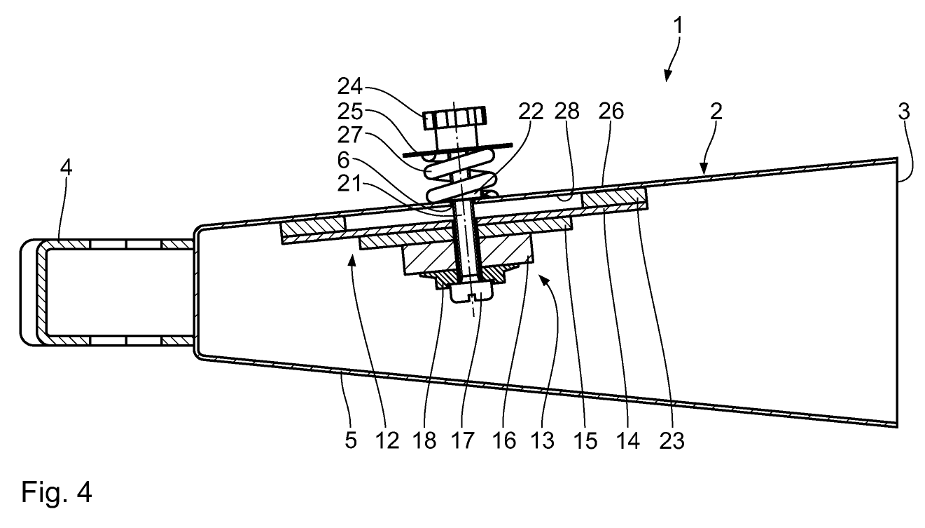

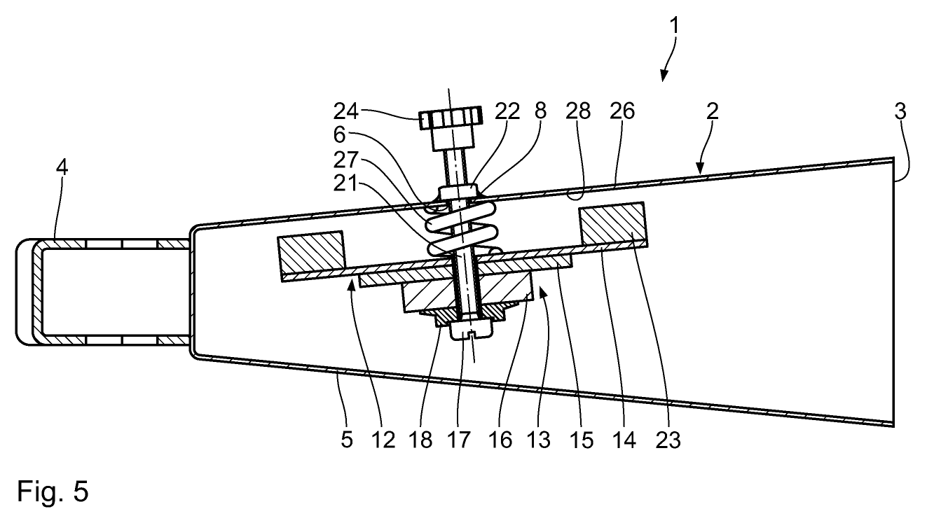

FIGS. 4 and 5 each show longitudinal sections through a third and fourth embodiment of the musical instrument with spring-actuated damping mechanisms.

A musical instrument 1 shown in the drawing that is commonly referred to as a cowbell has a bell-shaped metallic resonating body 2 that comprises a sound opening 3 and a fastening clip 4 disposed at the opposite, back end.

Provided on a long side of the resonating body 2 and penetrating its wall 5 is a bore 6 that is encompassed by a threaded nut 7, which is fixed in place by means of a weld seam 8.

A screw 9 extends through the nut 7 and is provided at its free end with a turning knob 10, all together creating a set screw 11.

The set screw 11 in conjunction with a damping element 12 all together form a damping mechanism 13.

The damping element 12 comprises a rubber washer 14 of large diameter, a felt washer 15 of smaller diameter, and an additional felt washer 16 of a denser felt material of yet smaller diameter.

The damping element 12 is fixed by means of a retaining head 17 of the screw 9 and a shim 18 on the set screw 11.

In the position shown in FIG. 1, the damping element 12 is not in contact with the wall 5 of the resonating body 2 and, consequently, does not produce any damping action.

By turning the set screw 11, the damping element 12 can be brought into contact with the inside of the wall 5, like it is shown in FIG. 2. Depending on the adjustment of the contact pressure of the damping element 12 onto the inside of the wall 5, the tone can be changed as desired.

In the exemplary embodiment described in conjunction with FIG. 1 and FIG. 2, the damping element 12 is pressed against the inside of the wall 5 by means of a pulling force.

In the embodiment depicted in FIG. 3, a one-piece damping element 12′ in the form of a felt block is pressed by a set screw 11′ against the wall 5 of the resonating body 2. This provides for corresponding adjustment options.

In the exemplary embodiment shown in FIG. 4, there is supported in the wall 5 of the resonating body 2 a support rod 21 in a guide bushing 22 in a manner so as to be displaceable, which carries at its inward end the multi-part damping element 12. In conformity with the exemplary embodiment according to FIGS. 1 and 2, a shim 18, two felt washers 16, 15, as well as a rubber washer 14 are fixed on the support rod by means of a screw 9. The rubber washer 14 is provided at its outer edge with a circumferential annular projection 23 whereby the damping element 12 is pressed against the wall 5.

Affixed to the outward end of the support rod 21 is a handle 24 that forms an abutment disk 25 of large diameter. Between it and the outside 26 of the wall 5 a helical compression spring 27 is mounted that moves the support rod 21 with the damping element 12 into the damping position shown in FIG. 4.

In order to play the musical instrument 1 undamped, it suffices to push the handle 24 toward the resonating body 2 so that the damping mechanism 13 is raised away from the wall 5 of the resonating body 2 and its tone is undamped in this respect.

The embodiment of the musical instrument shown in FIG. 5 corresponds to the exemplary embodiment of FIG. 4 in terms of the support of the damping mechanism 13 on a support rod 21 and the design of the damping element 12 and handle 24 for actuating the damping mechanism. Corresponding elements are marked with identical reference symbols. In terms of their explanation, reference may be made to the corresponding description of FIG. 4.

In contrast to the previous exemplary embodiment, the variant according to FIG. 5 has the helical compression spring 27 disposed on the inside of the wall 5 of the resonating body 2 and biased between the same and the rubber washer 14 as an abutment. This makes the damping mechanism 13 spring-biased in its inactive position with the damping element 12 raised away from the wall 5. The musical instrument 1 is accordingly played undamped in the configuration shown in FIG. 5. For damping purposes, the player pulls the damping mechanism 13 toward the inside 28 of the resonating body 2 by the handle 24 against the bias of the compression spring 27.

What is claimed is:

1. A musical rhythm instrument (1) with a bell-shaped resonating body (2), in particular of metal, characterized in that a damping mechanism (13) is provided for damping the vibrations of the resonating body (2).

2. A musical instrument (1) according to claim 1, characterized in that a damping element (13) is provided that is pressable against the wall of the resonating body (2).

3. A musical instrument (1) according to claim 2, characterized in that the damping element (13) consists of a soft material, such as felt, rubber, foamed plastic, or the like.

4. A musical instrument (1) according to claim 2, characterized in that the damping element (13) is pressable against the inner wall of the resonating body (2).

5. A musical instrument (1) according to claim 2, characterized in that the damping element (13) is composed of components of different materials and/or different sizes.

6. A musical instrument (1) according to claim 1, characterized in that the damping element (13) is adjustable by means of a set screw (11) in terms of its distance from and force of pressure against the inner wall of the resonating body (2).

7. A musical instrument (1) according to claim 6, characterized in that one wall of the resonating body (2) has a thread formed in it that is penetrated by the set screw (11).

8. A musical instrument (1) according to claim 6, characterized in that the set screw (11) presses or pulls the damping element (13) against the inner wall of the resonating body (2).

9. A musical instrument (1) according to claim 2, characterized in that the damping element (13) is disposed on a support rod (21) that is displaceable in the wall (5) of the resonating body (2) between an inactive position and a damping position and spring biased toward the damping position.

10. A musical instrument (1) according to claim 2, characterized in that the damping element (13) is disposed on a support rod (21) that is displaceable in the wall (5) of the resonating body (2) between an inactive position and a damping position and spring biased toward the inactive position.

11. A musical instrument (1) according to claim 9, characterized in that a compression spring (27) for spring actuation is disposed between the outside (26) of the wall (5) and an abutment (25) on the support rod (21).

12. A musical instrument (1) according to claim 10, characterized in that a compression spring (27) for spring actuation is disposed between the inside (28) of the wall (5) and the damping element (13).
